(19) United States
(12) Patent Application Publication
(10) Pub. No.: US 2025/0074462 A1
(43) Pub. Date: Mar. 6, 2025

(54) CONFIGURATION-BASED SAMPLING OF RUN SEGMENTS FOR SIMULATING AUTONOMOUS VEHICLE BEHAVIOR

(71) Applicant: Waymo LLC, Mountain View, CA (US)

(72) Inventors: Qiwu Zou, Mountain View, CA (US); Menghui Wang, Santa Clara, CA (US)

(21) Appl. No.: 18/239,168

(22) Filed: Aug. 29, 2023

(51) Int. Cl. B60W 60/00

(52) U.S. Cl. CPC B60W 60/0011; B60W 2554/4029

(57) ABSTRACT

Embodiments of the present disclosure relate to configuration-based sampling of run segments for simulating autonomous vehicle behavior. In at least one implementation, a method comprises: providing a set of run segments corresponding to scenarios for simulating operation of an autonomous vehicle; receiving a user-specified configuration comprising parameters for identifying target run segments within the set of run segments; applying the user-specified configuration to the set of run segments to identify the target run segments; and causing one or more simulations to be performed using the target run segments to generate a simulation output.

### TECHNICAL FIELD

The instant specification generally relates to autonomous vehicles. More specifically, the instant specification relates to identifying relevant simulation scenarios for validating decision logic for controlling autonomous vehicles.

### BACKGROUND

An autonomous (fully and partially self-driving) vehicle (AV) operates by sensing an outside environment with various electromagnetic (e.g., radar and optical) and non-electromagnetic (e.g., audio and humidity) sensors. Some autonomous vehicles chart a driving path through the environment based on the sensed data. The driving path can be determined based on Global Positioning System (GPS) data and road map data.

When updates are to be made to decision logic utilized by AV control systems, it is useful to simulate the performance of AVs in an artificial environment to validate the updates prior to real-world implementation. Run segments, which represent simulated scenarios based on real-world data, play an important role in the evaluation of behavior changes to reveal the impact of code updates. While large repositories of run segments exist for this purpose, it can be computationally inefficient to test code updates across a wide range of scenarios, in particular when many scenarios are simple and would provide very little insight into the impact of code updates on AV behavior. Random sampling or identification of run segments based simply on roadway type often overlook interesting scenarios for which important behavioral insights can be generated.

### SUMMARY

The following presents a simplified summary of various aspects of the present disclosure in order to provide a basic understanding of such aspects. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a method comprises: providing a set of run segments corresponding to scenarios for simulating operation of an AV; receiving a user-specified configuration comprising parameters for identifying target run segments within the set of run segments; applying the user-specified configuration to the set of run segments to identify the target run segments; and causing one or more simulations to be performed using the target run segments to generate a simulation output.

In at least one implementation, the method further comprises: generating the set of run segments by identifying as the set a subset of run segments sampled from a repository of run segments. In at least one implementation, the subset is sampled from the repository by selecting run segments comprising at least one agent object present in the corresponding simulation.

In at least one implementation, the user-specified configuration further comprises a target number of run segments to identify within the set of run segments.

In at least one implementation, the parameters for identifying the target run segments comprise one or more of roadway type, roadway construction, number of vehicles present, number of cyclists present, number of pedestrians present, number of non-moving vehicles present near-collision event, or agent heading direction.

In at least one implementation the user-specified configuration further comprises weights associated with the parameters for identifying the target run segments. In at least one implementation, applying the user-specified configuration to the set of run segments comprises generating a normalized sampling distribution for the set of run segments by applying a minimization algorithm to the set of run segments based on the weights. In at least one implementation the target run segments are identified by selecting run segments from the set of run segments in accordance with the normalized sampling distribution.

In at least one implementation, the simulation output is used to validate updated decision logic by comparing simulated performance of the AV with the updated decision logic to simulated performance of the AV based on a prior decision logic version.

In a further aspect of the present disclosure, a system comprises: a memory device; and a processing device, operatively coupled to the memory device, to perform operations comprising: providing a set of run segments corresponding to scenarios for simulating the operation of an AV; receiving a user-specified configuration comprising parameters for identifying target run segments within the set of run segments; applying the user-specified configuration to the set of run segments to identify the target run segments; and causing one or more simulations to be performed using the target run segments to generate a simulation output.

In at least one implementation, the operations further comprise: generating the set of run segments by identifying as the set a subset of run segments sampled from a repository of run segments. In at least one implementation, the subset is sampled from the repository by selecting run segments comprising at least one agent object present in the corresponding simulation.

In at least one implementation, the user-specified configuration further comprises a target number of run segments to identify within the set of run segments.

In at least one implementation, the parameters for identifying the target run segments comprise one or more of roadway type, roadway construction, number of vehicles present, number of cyclists present, number of pedestrians present, number of non-moving vehicles present near-collision event, or agent heading direction.

In at least one implementation, the user-specified configuration further comprises weights associated with the parameters for identifying the target run segments. In at least one implementation, applying the user-specified configuration to the set of run segments comprises generating a normalized sampling distribution for the set of run segments by applying a minimization algorithm to the set of run segments based on the weights. In at least one implementation, the target run segments are identified by selecting run segments from the set of run segments in accordance with the normalized sampling distribution.

In at least one implementation, the simulation output is used to validate updated decision logic by comparing simulated performance of the AV with the updated decision logic to simulated performance of the AV based on a prior decision logic version.

In a further aspect of the present disclosure, a non-transitory computer-readable medium has instructions encoded thereon that, when executed by a processing device, cause the processing device to perform operations comprising: providing a set of run segments corresponding to scenarios for simulating the operation of an autonomous vehicle (AV); receiving a user-specified configuration comprising parameters for identifying target run segments within the set of run segments; applying the user-specified configuration to the set of run segments to identify the target run segments; and causing one or more simulations to be performed using the target run segments to generate a simulation output.

In at least one implementation, the operations further comprise: generating the set of run segments by identifying as the set a subset of run segments sampled from a repository of run segments. In at least one implementation, the subset is sampled from the repository by selecting run segments comprising at least one agent object present in the corresponding simulation.

In at least one implementation, the user-specified configuration further comprises a target number of run segments to identify within the set of run segments.

In at least one implementation, the parameters for identifying the target run segments comprise one or more of roadway type, roadway construction, number of vehicles present, number of cyclists present, number of pedestrians present, number of non-moving vehicles present near-collision event, or agent heading direction.

In at least one implementation, the user-specified configuration further comprises weights associated with the parameters for identifying the target run segments. In at least one implementation, applying the user-specified configuration to the set of run segments comprises generating a normalized sampling distribution for the set of run segments by applying a minimization algorithm to the set of run segments based on the weights. In at least one implementation, the target run segments are identified by selecting run segments from the set of run segments in accordance with the normalized sampling distribution.

In at least one implementation, the simulation output is used to validate updated decision logic by comparing simulated performance of the AV with the updated decision logic to simulated performance of the AV based on a prior decision logic version.

### BRIEF DESCRIPTION OF THE DRAWINGS

The disclosure is illustrated by way of examples, and not by way of limitation, and can be more fully understood with references to the following detailed description when considered in connection with the figures, in which:

FIG. 1 is a diagram illustrating components of an exemplary AV, in accordance with some implementations of the present disclosure.

FIG. 2A is a diagram illustrating an exemplary simulation system for performing an AV driving simulation, in accordance with some implementations of the present disclosure.

FIG. 2B illustrates an exemplary simulated driving environment 250, in accordance with some implementations of the present disclosure.

FIG. 3 is a schematic illustrating the run segment structure for a run segments set downsampled from the run segment repository, in accordance with some implementations of the present disclosure.

FIG. 4 illustrates a workflow for identifying a run segment set from a run segment repository, in accordance with some implementations of the present disclosure.

FIG. 5 illustrates an exemplary data structure for a user-specified configuration, in accordance with some implementations of the present disclosure.

FIG. 6 illustrates an exemplary process flow for simulating run segments and updating a set of run segments, in accordance with some implementations of the present disclosure.

FIG. 7 illustrates application of the least squares model in target run segment selection, in accordance with some implementations of the present disclosure.

FIG. 8 is a flow diagram of an example method of configuration-based sampling of run segments for simulating autonomous vehicle behavior, in accordance with some implementations of the present disclosure.

FIG. 9 is a block diagram of an exemplary computer device within which a set of instructions, for causing the machine to perform any of the one or more methodologies discussed herein can be executed, in accordance with some implementations of the disclosure.

### DETAILED DESCRIPTION

Implementations of the present disclosure relate to approaches for sampling run segments for simulating AV behavior based on user-specified configurations to identify relevant scenarios for simulation and validation. For example, certain implementations generate subsets of run segments from large repositories of segments based on the presence of certain agents (e.g., moving objects such as pedestrians, vehicles, motorcycles, etc.). These subsets can then be further sampled based on desirable attributes for which a developer wishes to evaluate AV performance, with various attributes having an assigned weight that increases the probability of run segments having similar attributes being sampled.

In general, the goal of an AV evaluation workflow is to have a quantifiable measure of AV performance quality and to help developers understand the impact of code changes or updates. This allows an AV control system to be tested and validated before being implemented within the AV to improve how the AV responds to interactions with environmental objects/agents. AV motion planning or navigation methods can involve utilization of simulation data, which can be used to model the behavior of the AV control system. For example, in log-based simulations, the set of simulated data can include a set of simulated log data. The set of simulated data can include at least one set of simulated parameters. Each set of simulated parameters can define a feature of a simulated driving environment. For example, a set of simulated parameters can define the type of simulated driving environment (e.g., an intersection, a highway, a construction zone, or other environment), or a simulated object within the simulated driving environment (e.g., simulated agent, traffic light, cone, sign).

A simulation may be analyzed to observe behaviors (e.g., trajectory behaviors of the simulated AV and/or simulated agents) and detect events or interactions that have occurred during the simulation. For example, an event can be a negative event (e.g., a collision or near collision). These behaviors and events may be used for various purposes, such as determining whether the AV control system (e.g., software) can “pass” the simulation without a collision or near collision and to pinpoint the types of behaviors and/or software modules that may need attention in order to improve performance and safety, without requiring a vehicle to physically drive “real” miles or having to “manufacture” real-world situations.

One type of AV simulation is log-based simulation, which performs a simulation based on simulated log data. It can take a large number of simulations to adequately test the ability of the AV control software to handle a large number of different driving scenarios. Moreover, the simulated log data used to perform a simulation should model realistic driving scenarios that may be observed by an AV in a real-world driving scenario.

In general, it is desirable to simulate AV behavior using scenarios for which the AV is subject to greater risk. Manual selection of such scenarios from a repository, for example, by selecting scenarios having specific roadway constructions or geographies can weaken the testing scenario coverage because many scenarios that do not fall within those scopes could be overlooked. Moreover, the process to expand the scopes of such selections is not scalable, as this would require revisiting the weights of all scopes manually.

Aspects of the disclosure address the above challenges, along with others, by increasing the likelihood of selecting scenarios that are more sensitive to the impact of code changes. This can be done first by generating a subset of run segment scenarios from a larger repository where run segments are selected based on the presence of particular types of agents that have a tendency to result in riskier driving situations. Such subsets would have conditions more representative of issues facing developers in improving AV behavior, while also making the evaluation process more resource efficient by avoiding simulation of simple scenarios for which behavioral insights would be difficult to extract. Furthermore, aspects of the disclosure further provide developers the ability to weight particular attributes that are relevant to the types of situations and scenarios that they would like to test. Such weightings can be used to further sample the subset of run segments to identify highly relevant run segments without requiring manual selection.

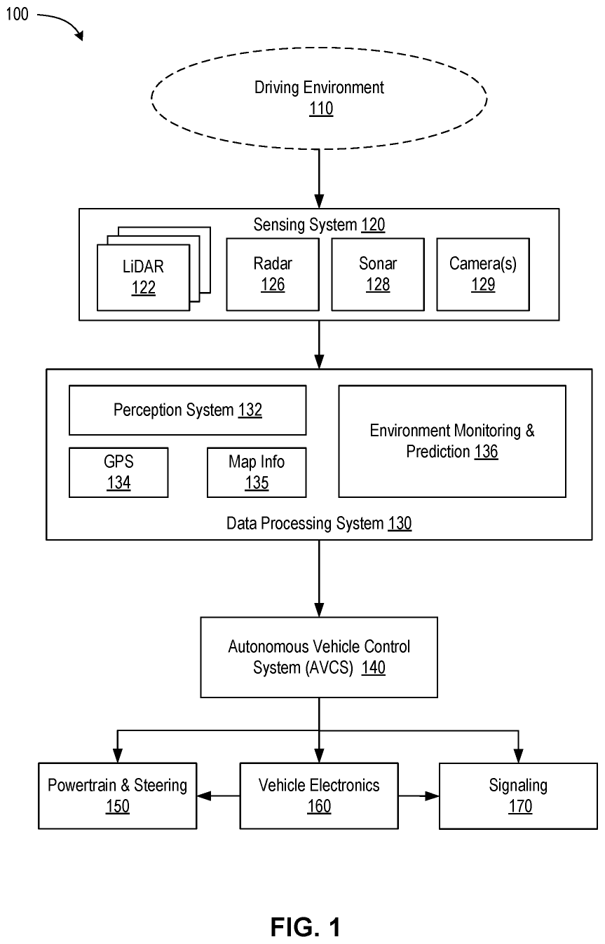

FIG. 1 is a diagram illustrating components of an exemplary AV 100 capable of using motion patterns for object classification and tracking, in accordance with some implementations of the present disclosure. FIG. 1 illustrates operations of the example autonomous vehicle. Autonomous vehicles can include motor vehicles (cars, trucks, buses, motorcycles, all-terrain vehicles, recreational vehicle, any specialized farming or construction vehicles, and the like), aircraft (planes, helicopters, drones, and the like), naval vehicles (ships, boats, yachts, submarines, and the like), or any other self-propelled vehicles (e.g., sidewalk delivery robotic vehicles) capable of being operated in a self-driving mode (without a human input or with a reduced human input).

Vehicles, such as those described herein, may be configured to operate in one or more different driving modes. For instance, in a manual driving mode, a driver may directly control acceleration, deceleration, and steering via inputs such as an accelerator pedal, a brake pedal, a steering wheel, etc. A vehicle may also operate in one or more autonomous driving modes including, for example, a semi or partially autonomous driving mode in which a person exercises some amount of direct or remote control over driving operations, or a fully autonomous driving mode in which the vehicle handles the driving operations without direct or remote control by a person. These vehicles may be known by different names including, for example, autonomously driven vehicles, self-driving vehicles, and so on.

As described herein, in a semi-autonomous or partially autonomous driving mode, even though the vehicle assists with one or more driving operations (e.g., steering, braking and/or accelerating to perform lane centering, adaptive cruise control, advanced driver assistance systems (ADAS), or emergency braking), the human driver is expected to be situationally aware of the vehicle's surroundings and supervise the assisted driving operations. Here, even though the vehicle may perform all driving tasks in certain situations, the human driver is expected to be responsible for taking control as needed.

Although, for brevity and conciseness, various systems and methods may be described below in conjunction with autonomous vehicles, similar techniques can be used in various driver assistance systems that do not rise to the level of fully autonomous driving systems. In the United States, the Society of Automotive Engineers (SAE) have defined different levels of automated driving operations to indicate how much, or how little, a vehicle controls the driving, although different organizations, in the United States or in other countries, may categorize the levels differently. More specifically, disclosed systems and methods can be used in SAE Level 2 driver assistance systems that implement steering, braking, acceleration, lane centering, adaptive cruise control, etc., as well as other driver support. The disclosed systems and methods can be used in SAE Level 3 driving assistance systems capable of autonomous driving under limited (e.g., highway) conditions. Likewise, the disclosed systems and methods can be used in vehicles that use SAE Level 4 self-driving systems that operate autonomously under most regular driving situations and require only occasional attention of the human operator. In all such driving assistance systems, accurate lane estimation can be performed automatically without a driver input or control (e.g., while the vehicle is in motion) and result in improved reliability of vehicle positioning and navigation and the overall safety of autonomous, semi-autonomous, and other driver assistance systems. As previously noted, in addition to the way in which SAE categorizes levels of automated driving operations, other organizations, in the United States or in other countries, may categorize levels of automated driving operations differently. Without limitation, the disclosed systems and methods herein can be used in driving assistance systems defined by these other organizations' levels of automated driving operations.

A driving environment 110 can include any objects (animated or non-animated) located outside the AV, such as roadways, buildings, trees, bushes, sidewalks, bridges, mountains, other vehicles, pedestrians, and so on. The driving environment 110 can be urban, suburban, rural, and so on. In some implementations, the driving environment 110 can be an off-road environment (e.g. farming or agricultural land). In some implementations, the driving environment can be an indoor environment, e.g., the environment of an industrial plant, a shipping warehouse, a hazardous area of a building, and so on. In some implementations, the driving environment 110 can be substantially flat, with various objects moving parallel to a surface (e.g., parallel to the surface of Earth). In other implementations, the driving environment can be three-dimensional and can include objects that are capable of moving along all three directions (e.g., balloons, leaves, etc.). Hereinafter, the term “driving environment” should be understood to include all environments in which an autonomous motion of self-propelled vehicles can occur. For example, “driving environment” can include any possible flying environment of an aircraft or a marine environment of a naval vessel. The objects of the driving environment 110 can be located at any distance from the AV, from close distances of several feet (or less) to several miles (or more).

The example AV 100 can include a sensing system 120. The sensing system 120 can include various electromagnetic (e.g., optical) and non-electromagnetic (e.g., acoustic) sensing subsystems and/or devices. The terms “optical” and “light,” as referenced throughout this disclosure, are to be understood to encompass any electromagnetic radiation (waves) that can be used in object sensing to facilitate autonomous driving, e.g., distance sensing, velocity sensing, acceleration sensing, rotational motion sensing, and so on. For example, “optical” sensing can utilize a range of light visible to a human eye (e.g., the 380 to 700 nm wavelength range), the ultraviolet range (below 380 nm), the infrared range (above 700 nm), the radio frequency range (above 1 m), etc. In implementations, “optical” and “light” can include any other suitable range of the electromagnetic spectrum.

The sensing system 120 can include a radar unit 126, which can be any system that utilizes radio or microwave frequency signals to sense objects within the driving environment 110 of the AV 100. The radar unit can be configured to sense both the spatial locations of the objects (including their spatial dimensions) and their velocities (e.g., using the Doppler shift technology). Hereinafter, “velocity” refers to both how fast the object is moving (the speed of the object) as well as the direction of the object's motion.

The sensing system 120 can include one or more lidar sensors 122 (e.g., lidar rangefinders), which can be a laser-based unit capable of determining distances (e.g., using ToF technology) to the objects in the driving environment 110. The lidar sensor(s) can utilize wavelengths of electromagnetic waves that are shorter than the wavelength of the radio waves and can, therefore, provide a higher spatial resolution and sensitivity compared with the radar unit. The lidar sensor(s) can include a coherent lidar sensor, such as a frequency-modulated continuous-wave (FMCW) lidar sensor. The lidar sensor(s) can use optical heterodyne detection for velocity determination. In some implementations, the functionality of a ToF and coherent lidar sensor(s) is combined into a single (e.g., hybrid) unit capable of determining both the distance to and the radial velocity of the reflecting object. Such a hybrid unit can be configured to operate in an incoherent sensing mode (ToF mode) and/or a coherent sensing mode (e.g., a mode that uses heterodyne detection) or both modes at the same time. In some implementations, multiple lidar sensor(s) 122 units can be mounted on AV, e.g., at different locations separated in space, to provide additional information about a transverse component of the velocity of the reflecting object, as described in more detail below.

The lidar sensor(s) 122 can include one or more laser sources producing and emitting signals and one or more detectors of the signals reflected back from the objects. The lidar sensor(s) 122 can include spectral filters to filter out spurious electromagnetic waves having wavelengths (frequencies) that are different from the wavelengths (frequencies) of the emitted signals. In some implementations, the lidar sensor(s) 122 can include directional filters (e.g., apertures, diffraction gratings, and so on) to filter out electromagnetic waves that can arrive at the detectors along directions different from the retro-reflection directions for the emitted signals. The lidar sensor(s) 122 can use various other optical components (lenses, mirrors, gratings, optical films, interferometers, spectrometers, local oscillators, and the like) to enhance sensing capabilities of the sensors.

In some implementations, the lidar sensor(s) 122 can scan 360-degree in a horizontal direction. In some implementations, the lidar sensor(s) 122 can be capable of spatial scanning along both the horizontal and vertical directions. In some implementations, the field of view can be up to 90 degrees in the vertical direction (e.g., with at least a part of the region above the horizon being scanned by the lidar signals). In some implementations, the field of view can be a full sphere (consisting of two hemispheres). For brevity and conciseness, when a reference to “lidar technology,” “lidar sensing,” “lidar data,” and “lidar,” in general, is made in the present disclosure, such reference shall be understood also to encompass other sensing technology that operate at generally in the near-infrared wavelength, but may include sensing technology that operate at other wavelengths.

The sensing system 120 can further include one or more cameras 129 to capture images of the driving environment 110. The images can be two-dimensional projections of the driving environment 110 (or parts of the driving environment 110) onto a projecting plane (flat or non-flat, e.g. fisheye) of the cameras. Some of the cameras 129 of the sensing system 120 can be video cameras configured to capture a continuous (or quasi-continuous) stream of images of the driving environment 110. The sensing system 120 can also include one or more sonars 128, which can be ultrasonic sonars, in some implementations.

The sensing data obtained by the sensing system 120 can be processed by a data processing system 130 of AV 100. For example, the data processing system 130 can include a perception system 132. The perception system 132 can be configured to detect and/or track objects in the driving environment 110 and to recognize the objects. For example, the perception system 132 can analyze images captured by the cameras 129 and can be capable of detecting traffic light signals, road signs, roadway layouts (e.g., boundaries of traffic lanes, topologies of intersections, designations of parking places, and so on), presence of obstacles, and the like. The perception system 132 can further receive the lidar sensing data (coherent Doppler data and incoherent ToF data) to determine distances to various objects in the environment 110 and velocities (radial and, in some implementations, transverse, as described below) of such objects. In some implementations, the perception system 132 can use the lidar data in combination with the data captured by the camera(s) 129. In one example, the camera(s) 129 can detect an image of a scene, such as a construction zone scene. Using the data from the camera(s) 129, lidar data, etc., the perception system 132 can be capable of determining the existence of objects within the scene (e.g., cones). For example, the perception system 132 can include a scene recognition component 133.

The perception system 132 can further receive information from a GPS transceiver (not shown) configured to obtain information about the position of the AV relative to Earth. The GPS data processing module 134 can use the GPS data in conjunction with the sensing data to help accurately determine location of the AV with respect to fixed objects of the driving environment 110, such as roadways, lane boundaries, intersections, sidewalks, crosswalks, road signs, surrounding buildings, and so on, locations of which can be provided by map information 135. In some implementations, the data processing system 130 can receive non-electromagnetic data, such as sonar data (e.g., ultrasonic sensor data), temperature sensor data, pressure sensor data, meteorological data (e.g., wind speed and direction, precipitation data), and the like.

The data processing system 130 can further include an environment monitoring and prediction component 136, which can monitor how the driving environment 110 evolves with time, e.g., by keeping track of the locations and velocities of the animated objects (relative to Earth). In some implementations, the environment monitoring and prediction component 136 can keep track of the changing appearance of the environment due to motion of the AV relative to the environment. In some implementations, the environment monitoring and prediction component 136 can make predictions about how various animated objects of the driving environment 110 will be positioned within a prediction time horizon. The predictions can be based on the current locations and velocities of the animated objects as well as on the tracked dynamics of the animated objects during a certain (e.g., predetermined) period of time. For example, based on stored data for object 1 indicating accelerated motion of object 1 during the previous 3-second period of time, the environment monitoring and prediction component 136 can conclude that object 1 is resuming its motion from a stop sign or a red traffic light signal. Accordingly, the environment monitoring and prediction component 136 can predict, given the layout of the roadway and presence of other vehicles, where object 1 is likely to be within the next 3 or 5 seconds of motion. As another example, based on stored data for object 2 indicating decelerated motion of object 2 during the previous 2-second period of time, the environment monitoring and prediction component 136 can conclude that object 2 is stopping at a stop sign or at a red traffic light signal. Accordingly, the environment monitoring and prediction component 136 can predict where object 2 is likely to be within the next 1 or 3 seconds. The environment monitoring and prediction component 136 can perform periodic checks of the accuracy of its predictions and modify the predictions based on new data obtained from the sensing system 120.

The data generated by the perception system 132, the GPS data processing module 134, the environment monitoring and prediction component 136, and the motion planning blueprint generator 138 can be received by an autonomous driving system, such as AV control system (AVCS) 140. The AVCS 140 can include one or more algorithms that control how the AV is to behave in various driving situations and environments.

For example, the AVCS 140 can include a navigation system for determining a global driving route to a destination point. The AVCS 140 can also include a driving path selection system for selecting a particular path through the immediate driving environment, which can include selecting a traffic lane, negotiating a traffic congestion, choosing a place to make a U-turn, selecting a trajectory for a parking maneuver, and so on. The AVCS 140 can also include an obstacle avoidance system for safe avoidance of various obstructions (cones, rocks, stalled vehicles, a jaywalking pedestrian, and so on) within the driving environment of the AV. The obstacle avoidance system can be configured to evaluate the size of the obstacles and the trajectories of the obstacles (if obstacles are animated) and select an optimal driving strategy (e.g., braking, steering, accelerating, etc.) for avoiding the obstacles.

Algorithms and modules of AVCS 140 can generate instructions for various systems and components of the vehicle, such as the powertrain and steering 150, vehicle electronics 160, signaling 170, and other systems and components not explicitly shown in FIG. 1. The powertrain and steering 150 can include an engine (internal combustion engine, electric engine, and so on), transmission, differentials, axles, wheels, steering mechanism, and other systems. The vehicle electronics 160 can include an on-board computer, engine management, ignition, communication systems, carputers, telematics, in-car entertainment systems, and other systems and components. The signaling 170 can include high and low headlights, stopping lights, turning and backing lights, horns and alarms, inside lighting system, dashboard notification system, passenger notification system, radio and wireless network transmission systems, and so on. Some of the instructions output by the AVCS 140 can be delivered directly to the powertrain and steering 150 (or signaling 170) whereas other instructions output by the AVCS 140 are first delivered to the vehicle electronics 160, which generate commands to the powertrain and steering 150 and/or signaling 170.

In one example, the AVCS 140 can determine that an obstacle identified by the data processing system 130 is to be avoided by decelerating the vehicle until a safe speed is reached, followed by steering the vehicle around the obstacle. The AVCS 140 can output instructions to the powertrain and steering 150 (directly or via the vehicle electronics 160) to 1) reduce, by modifying the throttle settings, a flow of fuel to the engine to decrease the engine rpm, 2) downshift, via an automatic transmission, the drivetrain into a lower gear, 3) engage a brake unit to reduce (while acting in concert with the engine and the transmission) the vehicle's speed until a safe speed is reached, and 4) perform, using a power steering mechanism, a steering maneuver until the obstacle is safely bypassed. Subsequently, the AVCS 140 can output instructions to the powertrain and steering 150 to resume the previous speed settings of the vehicle.

The functionality of the data processing system 130 and/or the AVCS 140 can be improved by updating one or more components of the data processing system 130 and/or the AVCS 140. For example, one or more components of the data processing system 130 and/or the AVCS 140 can be updated based on simulations performed using simulated data.

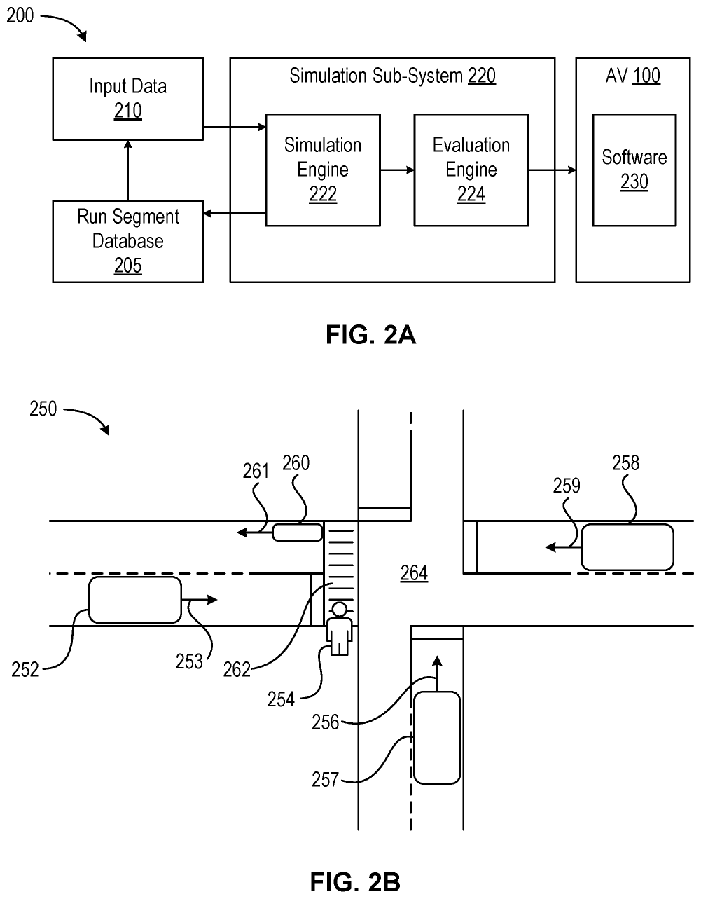

FIG. 2 is a diagram illustrating an exemplary simulation system 200 for performing an AV driving simulation, in accordance with some implementations of the present disclosure. As shown, the system 200 can receive AV simulation input data (“input data”) 210. The input data 210 can include a run segment obtained (e.g., collected) by or derived from data obtained an AV (e.g., the AV 100 of FIG. 1) during operation of the AV within a real-world driving environment. For example, the run segment can be log data generated at least in part by or at least partially derived from data obtained by an AV control system of the AV (e.g., the AVCS 140 of the AV 100 of FIG. 1). In at least one implementation, the run segments are sourced from a run segment database 205, which may store a repository of run segments, as well as subsets of run segments selected from the repository). For example, the run segment database 205 may be updated at various intervals, such as weekly, monthly, or quarterly. In at least one implementation, the input data 210 further includes software code or a software code update to be implemented by a simulated AV during simulation of a run segment in order to evaluate the performance of the software code or software code update.

In at least one implementation, the input data 210 is descriptive of real-world data and can include at least one set of real-world parameters. Each set of real-world parameters can define a real-world object observed by the AV operating within a real-world driving environment. In some implementations, a real-world object is a real-world agent. Examples of real-world agents include, for example, other vehicles, pedestrians, bicyclists, animals, etc. The input data 210 may comprise a run segment, which represents an environment for a fixed duration of time generated, for example, from historical log data of an actual scenario through which an AV navigated, an artificially generated scenario, or a modified historical scenario. In at least one implementation, a run segment can include a plurality of parameters descriptive of objects/agents present in, events that occurred in, and/or environmental parameters associated with the environment represented by the run segment. Such parameters can include, but are not limited to, roadway type, roadway construction, number of vehicles present, number of cyclists present, number of pedestrians present, number of non-moving vehicles present near-collision event, or agent heading direction(s).

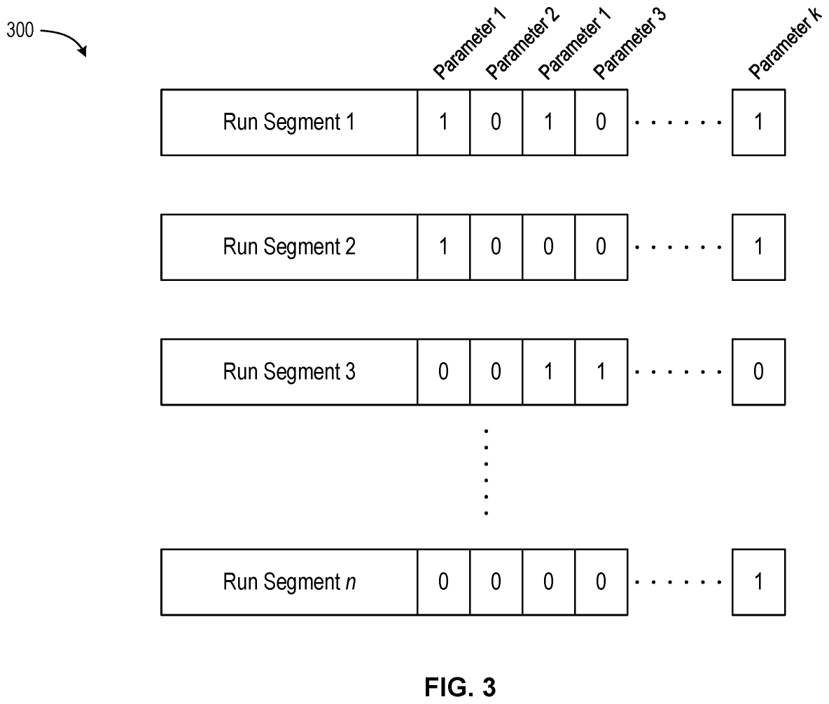

A run segment may further comprise searchable metadata that is descriptive of these various parameters. In at least one implementation, the parameters described by the metadata may be representative of binary attributes related to the simulated environment that it describes. Examples of binary attributes include “has at least one vehicle agent,” “has motorcyclist,” “location is in San Francisco,” “is at an intersection,” “has object near AV trajectory,” “has close-call event,” or other descriptive features that can be represented as binary attributes. In at least one embodiment, the metadata may be manually entered by a user, generated from classifications using a machine-learning algorithm, or a combination thereof. For example, FIG. 3 illustrates a run segment set 300 having n run segments, with each run segment being characterized by a total of k parameters. Each parameter may correspond to a binary attributes, as discussed above. For example, if parameter 1 corresponds to the attributes “has motorcyclist” and this attributes is to be used to identify run segments that can simulate a scenario in which at least one motorcyclist is present, then run segments 1 and 2 will be selected.

FIG. 2B illustrates an exemplary simulated driving environment 250, in accordance with some implementations of the present disclosure. The simulated driving environment 250 can correspond to a scenario described by a run segment on which a simulation can be performed, as discussed above with respect to FIG. 2A. In this illustrative example, the simulated driving environment 250 includes a simulated AV 252, which may be representative of the AV 100, and various agents including a simulated pedestrian 254 entering a crosswalk 262, a first simulated vehicle 256, a second simulated vehicle 258, and a simulated cyclist 260 (which may be representative of a bicyclist or motorcyclist). Each of the simulated AV 252, the first simulated vehicle 256, the second simulated vehicle 258, and the simulated cyclist 260 may have an associated heading direction 253, 257, 259, and 261, respectively. The simulated driving environment 250 shown is representative of an intersection 264, though other types of roadways can be simulated, such as a multi-lane intersection, a single-lane road, a highway, or other suitable driving environment. In at least one implementation, the associated run segment may provide the simulated AV 252 with a set of default initial run settings, or the initial run settings may adjusted. For example, the run settings may include one or more of dimensions of the AV 252, a speed, a location, the heading direction 253, or other settings.

The simulated driving environment 250 may correspond to a particular scenario for testing the response of the AV 252 to a hazard or close-call event. For example, the simulated driving environment 250 may simulate a situation in which the AV 252 is about to enter the intersection 264 just as the simulated pedestrian 254 unlawfully enters the crosswalk 262. The output of simulating the run segment representative of the simulated driving environment 250 may be used to evaluate the performance of the AV 252 in this situation. For example, if the simulation output indicates poor performance in which the AV 252 is determined to have a negative event (e.g., a collision or near collision with the simulated pedestrian 254), then the simulation can be deemed a failure and remedial actions can be taken to improve how the AV control software reacts to the set of simulated driving environment 250.

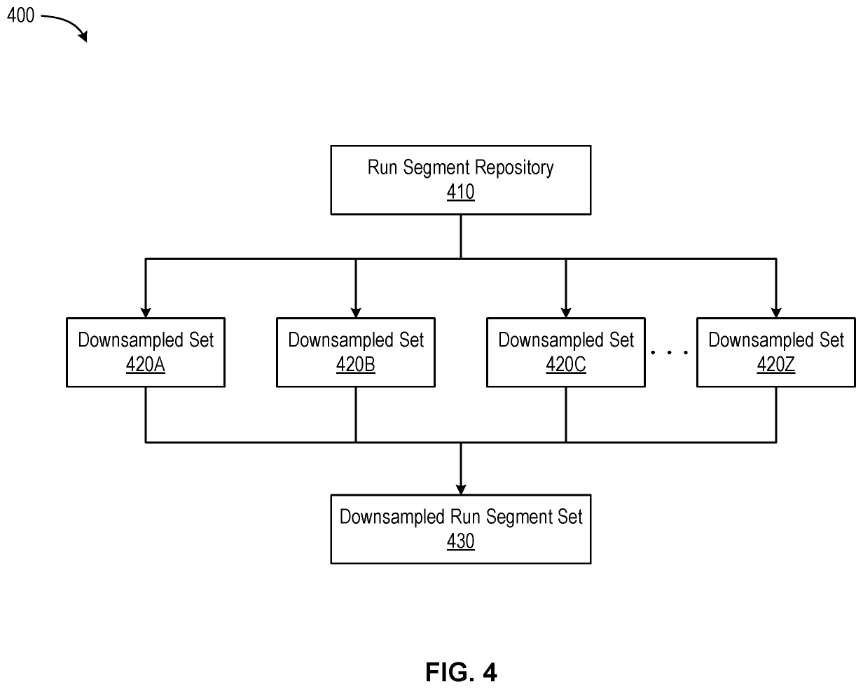

Returning to FIG. 2A, simulation system 200 further include a simulation sub-system 220 that performs time-based simulations using the input data 210. The simulation sub-system can include a processing device and/or can be executed by a processing device as software and/or firmware. In at least on implementation, the simulation is of a simulated AV operating in a simulated driving environment. For example, the simulation sub-system 220 can include a log-based simulator configured to perform a simulation based on a run segment, with other parameters or metrics of the simulation being specified in the input data 210. As further shown, the simulation sub-system 220 includes a simulation engine 222 configured to perform a simulation based on the input data 210. In at least one implementation, the simulation engine 222 may receive as input data 210 a user-specified configuration that identifies relevant parameters for which a user wishes to simulate using the simulation engine 222. In such implementations, the simulation engine 222 my identify within the run segment database 205 a subset of run segments based on the user-specified configuration. This functionality is described in greater detail below with respect to FIG. 4.

The simulation sub-system 220 further includes an evaluation engine 224 for evaluating the simulation output of the simulation engine 222. The simulation output can reflect a performance of the simulated AV operating within the simulated driving environment. For example, the simulation output can indicate a number of negative events that occurred during the simulation (e.g., a number of collisions or near collisions).

In at least one implementation, the AV 100 can include AV control software (“software”) 230. The simulation output can be used to improve one or more components of the AV 100 (e.g., the data processing system 130 and/or the AVCS 140 of FIG. 1) by updating and/or modifying the software 340. For example, simulation can be used to test an update to the AV control software as part of the input data 210, and the simulation output can be used to determine whether the updated AV control software has performed satisfactorily during simulation. In some implementations, determining whether the updated AV control software has performed satisfactorily during simulation includes determining whether its performance satisfies a threshold condition. For example, determining whether the updated AV control software has performed satisfactorily during simulation can include determining whether the number of negative events occurred during simulation satisfies a threshold condition (e.g., the number of negative events is less than or equal to a threshold number of negative events).

In at least one implementation, if the updated AV control software is determined to have performed satisfactorily during simulation, the updated AV control software can be identified by the evaluation engine 224 as validated and the update to the AV control software can be integrated within the AVCS 140 by updating the software 230 to improve the operation of the AV while in an autonomous driving mode. In at least one implementation, if the updated AV control software is determined to have performed unsatisfactory during simulation (i.e., failed), then the update to the AV control software can be identified by the evaluation engine 224 as a failed update, and the issue(s) with the failed update can be addressed. Addressing the issues(s) with the failed update can include performing at least one of: flagging the failed update for review, analyzing the failed update to generate simulation metrics for review, modifying the update to improve operation of the simulated AV within the simulated driving environment, etc. Addressing the issues(s) with the failed update can further include modifying the update and performing a new simulation using the same run segment or different run segments, in accordance with the modified update, to obtain a new simulation output. If the new simulation output indicates that the modified update has performed satisfactorily, then the modified update can be integrated within the AV 100.

FIG. 4 illustrates a workflow 400 for identifying a run segment set from a run segment repository, in accordance with some implementations of the present disclosure. In at least one implementation, the workflow 400 is implemented by the simulation system 200. The run segment repository 410, which may be stored in the run segment database 205, includes a comprehensive collection of run segments corresponding to real-world data obtained during operation of AVs in various environments, scenarios based on real-world data that have been modified, or artificially generated scenarios.

Typically, a run segment repository include a number of run segments (e.g., greater than 10 million run segments, or greater than 100 million run segments) that is impractical to simulate. The coverage of scenarios captured by the run segments can be largely irrelevant to the scenarios for which a developer desires to test. In at least one implementation, the workflow 400 is used to downsample the run segment repository 410 in order to identify subsets of run segments that are likely to correspond to scenarios of interest to developers. In at least one implementation, a plurality of downsampled sets 420A-420Z may be identified within the run segment repository 410. Each of the downsampled sets 420A-420Z may correspond to a random sampling of the run segment repository 410 for which a particular condition is met. The conditions may include the presence of at least one car, the presence of at least one bicyclist, the presence of at least one motorcyclist, the presence of at least one pedestrian, or another suitable attributes. For example, to generate downsampled set 420A, a random run segment is selected from the run segment repository 410. If the random run segment does not satisfy the condition of having at least one car present (i.e., the condition associated with the downsampled set 420A), it will not be added to the downsampled set 420A. The process can be repeated until a specified number of run segments satisfying this condition are identified, which are added to the downsampled set 420A.

In such cases where certain types of scenarios may be sparse within the run segment repository 410 (e.g., run segments having bicyclists or motorcyclists may represent less than 0.1% of the total run segments in the run segment repository 410), greater weight may be given to the selection of such downsampled sets to produced a more balanced sampling (e.g., by adjusting relative target sizes of the various downsampled sets 420A-420Z).

In at least one implementation, once the downsampled sets 420A-420Z are identified, they are merged into a single downsampled run segment set 430, which is used as the basis for downstream selection of target run segments for simulating. In at least one implementation, the relative sizes of the downsampled sets may be selected such that the total size of the downsampled run segment set 430 is smaller than the run segment repository 410, for example, by a factor of 2, by a factor of 3, by a factor of 4, by a factor of 5, by a factor of 10, by a factor of 50, etc. In at least one implementation, the size of the downsampled run segment set 430 is less than 1 million run segments (e.g., about 500,000 run segments). It is noted that the notation “A-Z” is an arbitrary designation, and is intended to suggest that any number of sets may be used (e.g., a single downsampled set, 2 downsampled sets, 4 downsampled sets, etc.).

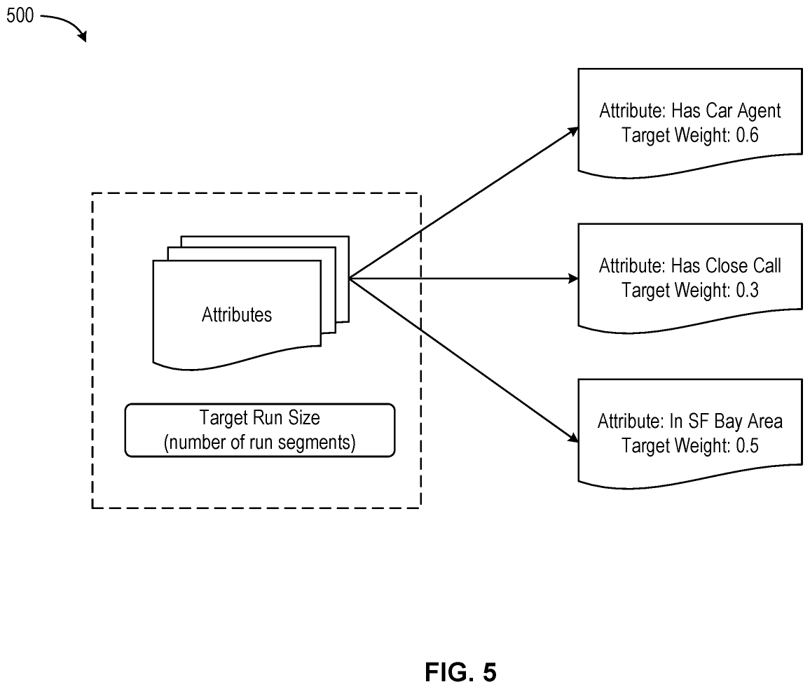

FIG. 5 illustrates an exemplary data structure for a user-specified configuration 500, in accordance with some implementations of the present disclosure. The user-specified configuration 500 may contain a collection of attributes specified by a user (e.g., a developer who wishes to test a code update for an AV control system in a plurality of simulated environments). In at least one implementation, each attribute corresponds to a binary attribute associated with the metadata of the run segments in the run segment set 430. For each attribute of interest, the user can also specify a weight value (e.g., from 0.0 to 1.0) to assign to the attribute, which affects the rate at which target run samples are sampled from the run segment set 430. The user may also specify a target run size (i.e., a target number of run segments) to provide the user with control over the number of simulations performed, for which fewer run segments may be desired depending on the amount of computing resources available to the simulation system 200.

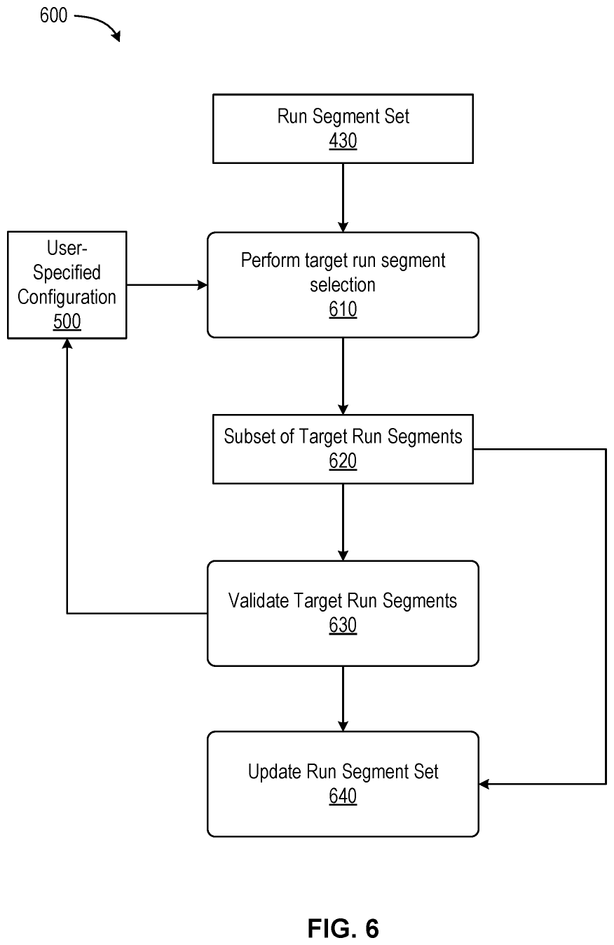

FIG. 6 illustrates an exemplary process flow 600 for simulating run segments and updating a set of run segments, in accordance with some implementations of the present disclosure. In at least one implementation, block 610 (which may be implemented by the simulation engine 222) performs a target run segment selection that utilized the user-specified configuration 500 to identify target run segments within the run segment set 430.

In at least one implementation, the user-specified configuration 500 is applied to identify target run segments using a least squares method, according to:

$$minimize {‖A}^{T} w - mb ‖ ,$$

$$such that$$

$${\sum }_{i = 1}^{n} {w}_{i} = m , 1 \geq {w}_{i} > 0 , m \leq n ,$$

where A^{T} is a matrix representing attributes of each run segment in the run segment set 430, w is a vector to be solved for representative of a sampling probability for each run segment in the run segment set 430, b is a vector representative of a desired feature distribution (based on the user-specified configuration 500), n is the total number of run segments in the run segment set 430, m is the target number of run segments (based on the user-specified configuration 500), and k is the number of attributes that describe each run segment (e.g., as illustrated in FIG. 3). In at least one implementation, A^{T} is an k×n matrix, with each column representing the attributes of a particular run segment. Based on these parameters, the sampling weight vector w is calculated to result in a minimized feature population difference.

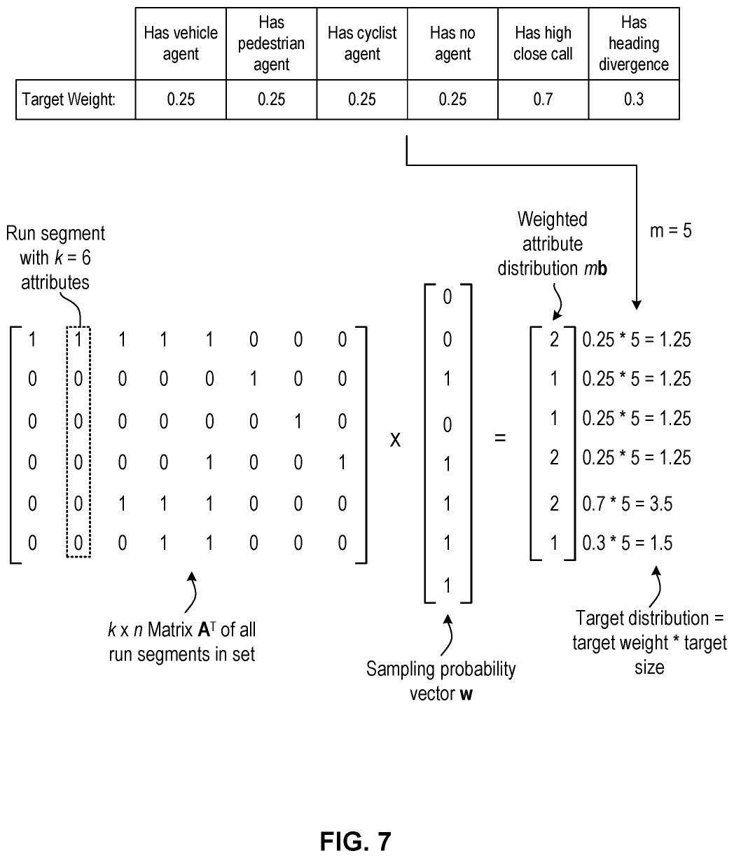

FIG. 7 illustrates application of the least squares model in target run segment selection, in accordance with some implementations of the present disclosure. The matrix A^{T} is shown as a 6×8 matrix, with each column corresponding to a run segment characterized by six different binary attributes. The weighted attribute distribution (mb) corresponds to the weights assigned by the user-specified configuration. Solving for the sampling probability vector w produces the sampling distribution where each row corresponds to one of the 8 run segments, where wᵢ represents the probability of run segment i being selected. FIG. 7 also shows an example of a target feature distribution specified by the user (e.g., having a weight of 0.25 for the attribute “has vehicle agent,” a weight of 0.25 for the attribute “has pedestrian agent,” etc.). After applying the least squares model (minimization), the resulting weighted attribute distribution is close to the target feature distribution, though the discrepancies between the two are expected to be lower when the number of run segments is higher.

Referring again to FIG. 6, once the target run segments are sampled from the run segment set 430, validation of the target run segments is performed at block 630, for example, as discussed above with respect to the evaluation engine 224. In at least one implementation, one or more of the target run segments may be evaluated to determine if updates or replacement is needed. For example, two candidate subsets of the target run segments may be generated (e.g., 70% for training, and 30% for evaluation).

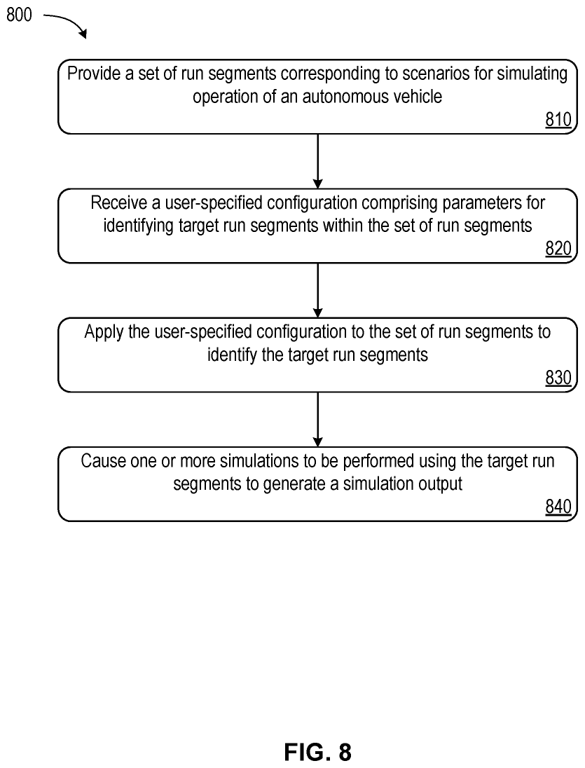

FIG. 8 is a flow diagram of an example method 800 of configuration-based sampling of run segments for simulating autonomous vehicle behavior, in accordance with some implementations of the present disclosure. The method 800 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. For example, the processing logic can be included within a simulator (e.g., the simulation sub-system 220 of FIG. 2). Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every implementation, and alternative process flows are contemplated.

At block 810, the processing logic receives or provides a set of run segments corresponding to scenarios for simulating operation of an autonomous vehicle (e.g., the run segment set 300 or 430 from the run segment database 205). In at least one implementation, each run segment is representative or descriptive of a driving environment over a fixed duration of time generated, for example, from historical log data of an actual scenario through which an AV navigated, an artificially generated scenario, or a modified historical scenario. In at least one implementation, each run segment can include a plurality of parameters descriptive of objects/agents present in, events that occurred in, and/or environmental parameters associated with the environment represented by the run segment. In at least one implementation, the parameters comprise one or more of roadway type, roadway construction, number of vehicles present, number of cyclists present, number of pedestrians present, number of non-moving vehicles present near-collision event, or agent heading direction. In at least one implementation, a run segment may further comprise searchable metadata that is descriptive of these various parameters. In at least one implementation, the parameters described by the metadata may be representative of binary attributes related to the simulated environment that it describes.

In at least one embodiment, the processing logic generates the set of run segments by identifying as the set a subset of run segments sampled from a repository of run segments. The subset may be sampled from the repository by selecting run segments comprising at least one agent object present in the corresponding simulation. The generation of the set of run segments may be performed, for example, as described with respect to the workflow 400 of FIG. 4.

At block 820, the processing logic receives a user-specified configuration (e.g., the user-specified configuration 500) that comprises parameters for identifying target run segments within the set of run segments. In at least one implementation, the user-specified configuration further comprises a target number of run segments to identify within the set of run segments. In at least one implementation, the user-specified configuration further comprises weights associated with the parameters for identifying the target run segments. For example, applying the user-specified configuration to the set of run segments comprises generating a normalized sampling distribution for the set of run segments by applying a minimization algorithm to the set of run segments based on the weights.

At block 830, the processing logic applies the user-specified configuration to the set of run segments to identify the target run segments. In at least one implementation, the target run segments are identified by selecting run segments from the set of run segments in accordance with the normalized sampling distribution.

At block 840, the processing logic causes one or more simulations to be performed (e.g., with the simulation engine 222) using the target run segments to generate a simulation output. In at least one implementation, the simulation output is used to validate (e.g., using the evaluation engine 224) updated decision logic by comparing simulated performance of the AV with the updated decision logic (e.g., software code) to simulated performance of the AV based on a prior version of the decision logic. In at least one implementation, if simulation is used to test an update to software utilized by an AV, and the simulated AV is determined to have performed satisfactorily during simulation, the performance may be deemed as acceptable. In such implementations, the decision logic (e.g., software 230) may be updated to include the decision logic tested during the one or more simulations. If the simulated AV is determined to have performed unsatisfactory during simulation, the processing logic may deem the decision logic to be a failed update. In at least one implementation, the processing logic may perform one or more further operations selected from: flagging the failed update for review, analyzing the failed update to generate simulation metrics, or modifying the failed update to improve operation of the simulated AV within the simulated driving environment defined by the one or more run segments.

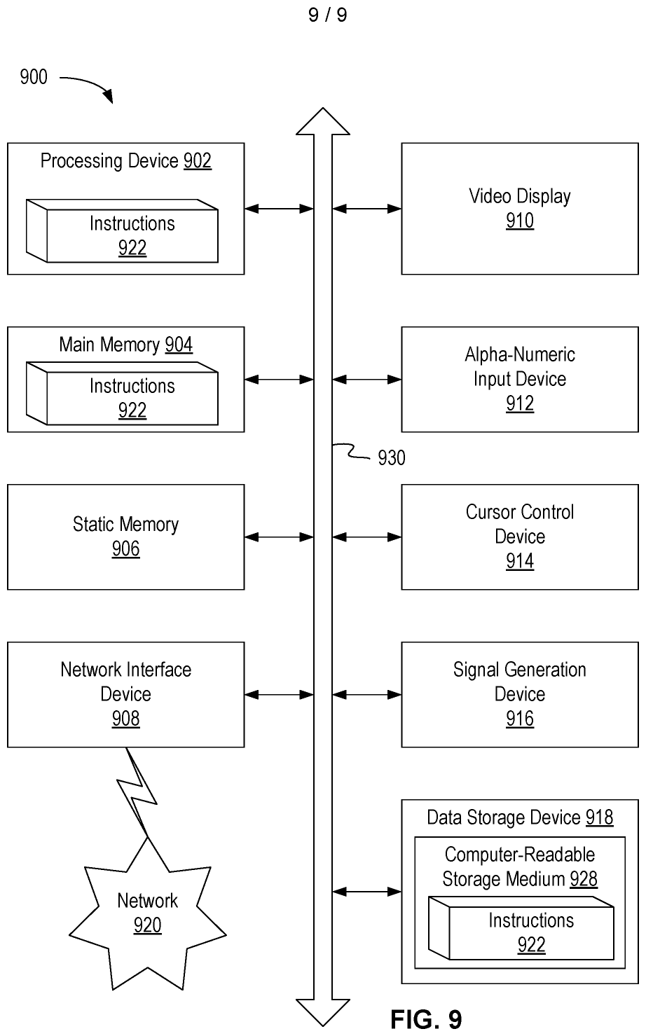

FIG. 9 depicts a block diagram of an exemplary computer device 900 within which a set of instructions, for causing the machine to perform any of the one or more methodologies discussed herein can be executed, in accordance with some implementations of the disclosure. Example computer device 900 can be connected to other computer devices in a LAN, an intranet, an extranet, and/or the Internet. Computer device 900 can operate in the capacity of a server in a client-server network environment. Computer device 900 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” includes any collection of computers that individually or jointly execute a set (or multiple sets) of instructions to perform any one or more of the methods discussed herein. In some implementations, the AV 100 and/or the simulation system 200 include the computer device 900.

The computer device 900 can include a processing device 902 (also referred to as a processor or CPU), which can include processing logic 903, a main memory 904 (e.g., read-only memory (ROM), flash memory, dynamic random access memory (DRAM) such as synchronous DRAM (SDRAM), etc.), a static memory 906 (e.g., flash memory, static random access memory (SRAM), etc.), and a secondary memory (e.g., a data storage device 918), which can communicate with each other via a bus 930.

Processing device 902 represents one or more general-purpose processing devices such as a microprocessor, central processing unit, or the like. More particularly, processing device 902 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 902 can also be one or more special-purpose processing devices such as an application specific integrated circuit (ASIC), a field programmable gate array (FPGA), a digital signal processor (DSP), network processor, or the like. In accordance with one or more aspects of the disclosure, processing device 902 can be configured to execute instructions performing any of the operations performed by the AV 100 and/or the simulation sub-system 220.

Example computer device 900 can further comprise a network interface device 808, which can be communicatively coupled to a network 920. Example computer device 900 can further comprise a video display 910 (e.g., a liquid crystal display (LCD), a touch screen, or a cathode ray tube (CRT)), an alphanumeric input device 912 (e.g., a keyboard), a cursor control device 914 (e.g., a mouse), and an acoustic signal generation device 916 (e.g., a speaker).

Data storage device 918 can include a computer-readable storage medium (or, more specifically, a non-transitory computer-readable storage medium) 928 on which is stored one or more sets of executable instructions 922. In accordance with one or more aspects of the disclosure, executable instructions 922 can comprise executable instructions to perform any of the operations of AV 100 and/or the simulation sub-system 220.

Executable instructions 922 can also reside, completely or at least partially, within main memory 904 and/or within processing device 902 during execution thereof by example computer device 900, main memory 904 and processing device 902 also constituting computer-readable storage media. Executable instructions 922 can further be transmitted or received over a network via network interface device 908.

While the computer-readable storage medium 928 is shown in FIG. 9 as a single medium, the term “computer-readable storage medium” should be taken to include a single medium or multiple media (e.g., a centralized or distributed database, and/or associated caches and servers) that store the one or more sets of VM operating instructions. The term “computer-readable storage medium” includes any medium that is capable of storing or encoding a set of instructions for execution by the machine that cause the machine to perform any one or more of the methods described herein. The term “computer-readable storage medium” includes, but is not limited to, solid-state memories, and optical and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the disclosure is not described with reference to any particular programming language. It will be appreciated that a variety of programming languages can be used to implement the teachings of the disclosure as described herein.

The disclosure can be provided as a computer program product, or software, that can include a machine-readable medium having stored thereon instructions, which can be used to program a computer system (or other electronic devices) to perform a process according to the disclosure. A machine-readable medium includes any mechanism for storing information in a form readable by a machine (e.g., a computer). In some implementations, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation,” “one implementation,” “some implementations,” “an implementation,” “one implementation,” “some implementations,” or the like throughout may or may not mean the same implementation or implementation. One or more implementations or implementations described herein may be combined in a particular implementation or implementation. The terms “first,” “second,” “third,” “fourth,” etc. as used herein are meant as labels to distinguish among different elements and may not necessarily have an ordinal meaning according to their numerical designation.

In the foregoing specification, implementations of the disclosure have been described with reference to specific example implementations thereof. It will be evident that various modifications can be made thereto without departing from the broader spirit and scope of implementations of the disclosure as set forth in the following claims. The specification and drawings are, accordingly, to be regarded in an illustrative sense rather than a restrictive sense.

What is claimed is:

1. A method comprising:
providing, by a processing device, a set of run segments corresponding to scenarios for simulating operation of an autonomous vehicle (AV);
receiving, by the processing device, a user-specified configuration comprising parameters for identifying target run segments within the set of run segments;
applying, by the processing device, the user-specified configuration to the set of run segments to identify the target run segments; and
causing, by the processing device, one or more simulations to be performed using the target run segments to generate a simulation output.

2. The method of claim 1, further comprising:
generating the set of run segments by identifying as the set a subset of run segments sampled from a repository of run segments, wherein the subset is sampled from the repository by selecting run segments comprising at least one agent object present in the corresponding simulation.

3. The method of claim 1, wherein the user-specified configuration further comprises a target number of run segments to identify within the set of run segments.

4. The method of claim 1, wherein the parameters for identifying the target run segments comprise one or more of roadway type, roadway construction, number of vehicles present, number of cyclists present, number of pedestrians present, number of non-moving vehicles present near-collision event, or agent heading direction.

5. The method of claim 1, wherein the user-specified configuration further comprises weights associated with the parameters for identifying the target run segments, and wherein applying the user-specified configuration to the set of run segments comprises generating a normalized sampling distribution for the set of run segments by applying a minimization algorithm to the set of run segments based on the weights.

6. The method of claim 5, wherein the target run segments are identified by selecting run segments from the set of run segments in accordance with the normalized sampling distribution.

7. The method of claim 1, wherein the simulation output is used to validate updated decision logic by comparing simulated performance of the AV with the updated decision logic to simulated performance of the AV based on a prior decision logic version.

8. A system comprising:
a memory device; and
a processing device, operatively coupled to the memory device, to perform operations comprising:
providing a set of run segments corresponding to scenarios for simulating the operation of an autonomous vehicle (AV);
receiving a user-specified configuration comprising parameters for identifying target run segments within the set of run segments;
applying the user-specified configuration to the set of run segments to identify the target run segments; and
causing one or more simulations to be performed using the target run segments to generate a simulation output.

9. The system of claim 8, the operations further comprising:
generating the set of run segments by identifying as the set a subset of run segments sampled from a repository of run segments, wherein the subset is sampled from the repository by selecting run segments comprising at least one agent object present in the corresponding simulation.

10. The system of claim 8, wherein the user-specified configuration further comprises a target number of run segments to identify within the set of run segments.

11. The system of claim 8, wherein the parameters for identifying the target run segments comprise one or more of roadway type, roadway construction, number of vehicles present, number of cyclists present, number of pedestrians present, number of non-moving vehicles present near-collision event, or agent heading direction.

12. The system of claim 8, wherein the user-specified configuration further comprises weights associated with the parameters for identifying the target run segments, and wherein applying the user-specified configuration to the set of run segments comprises generating a normalized sampling distribution for the set of run segments by applying a minimization algorithm to the set of run segments based on the weights.

13. The system of claim 12, wherein the target run segments are identified by selecting run segments from the set of run segments in accordance with the normalized sampling distribution.

14. The system of claim 8, wherein the simulation output is used to validate updated decision logic by comparing simulated performance of the AV with the updated decision logic to simulated performance of the AV based on a prior decision logic version.

15. A non-transitory computer-readable medium having instructions encoded thereon that, when executed by a processing device, cause the processing device to perform operations comprising:
providing a set of run segments corresponding to scenarios for simulating the operation of an autonomous vehicle (AV);
receiving a user-specified configuration comprising parameters for identifying target run segments within the set of run segments;
applying the user-specified configuration to the set of run segments to identify the target run segments; and
causing one or more simulations to be performed using the target run segments to generate a simulation output.

16. The non-transitory computer-readable medium of claim 15, the operations further comprising:
generating the set of run segments by identifying as the set a subset of run segments sampled from a repository of run segments, wherein the subset is sampled from the repository by selecting run segments comprising at least one agent object present in the corresponding simulation.

17. The non-transitory computer-readable medium of claim 15, wherein the user-specified configuration further comprises a target number of run segments to identify within the set of run segments.

18. The non-transitory computer-readable medium of claim 15, wherein the parameters for identifying the target run segments comprise one or more of roadway type, roadway construction, number of vehicles present, number of cyclists present, number of pedestrians present, number of non-moving vehicles present near-collision event, or agent heading direction.

19. The non-transitory computer-readable medium of claim 15, wherein the user-specified configuration further comprises weights associated with the parameters for identifying the target run segments, wherein applying the user-specified configuration to the set of run segments comprises generating a normalized sampling distribution for the set of run segments by applying a minimization algorithm to the set of run segments based on the weights, and wherein the target run segments are identified by selecting run segments from the set of run segments in accordance with the normalized sampling distribution.

20. The non-transitory computer-readable medium of claim 15, wherein the simulation output is used to validate updated decision logic by comparing simulated performance of the AV with the updated decision logic to simulated performance of the AV based on a prior decision logic version.
